(19) United States
(12) Patent Application Publication
(10) Pub. No.: US 2004/0148097 A1
(43) Pub. Date: Jul. 29, 2004

(54) Transmission of vehicle position relative to map database

(75) Inventors: Mike Mouser, Rancho Cucamonga, CA (US); Larry Spencer, Lake Orion, MI (US); John D. Begin, Sterling Heights, MI (US)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: MAGELLAN DIS, INC.

(21) Appl. No.: 10/719,016

(22) Filed: Nov. 24, 2003

Related U.S. Application Data
(63) Continuation-in-part of application No. 09/606,616, filed on Jun. 29, 2000, now abandoned.
(60) Provisional application No. 60/142,107, filed on Jul. 2, 1999.

(51) Int. Cl. G01C 21/26

(52) U.S. Cl. 701/207; 701/213; 340/989

(57) ABSTRACT

A method and system for transmitting the position of a vehicle to a remote location, the LOCUS position of the vehicle is calculated at the vehicle relative to a map database. The vehicle navigation system calculates its LOCUS position relative to the map database using map matching prior to sending that calculated position to the remote location. The LOCUS position of the vehicle is then transmitted to the remote location relative to the road network in the map database.

### CROSS-REFERENCE TO RELATED APPLICATIONS AND CLAIM OF PRIORITY

This application is a Continuation-in part of application Ser. No. 09/606,616 filed in the U.S. Patent and Trademark Office on Jun. 29, 2000 and is based on U.S. Provisional Patent Application Serial No. 60/142,107 filed Jul. 2, 1999, priority being hereby claimed based on these applications.

### BACKGROUND OF THE INVENTION

The present invention relates generally to vehicle location systems and more particularly to a vehicle location system where the vehicle position is transmitted to a remote location with reference to a map database stored in the vehicle system.

Several types of known vehicle location systems transmit the position of a remote vehicle to another location. For example, an emergency assistance request system on a vehicle transmits the location of the vehicle to an emergency assistance dispatch station along with a request for assistance. As another example, vehicle location systems are installed on fleets of vehicles, such as trucks, service vehicles or police cars, so that their location and progress can be tracked from a central location.

These known systems use Global Positioning System (GPS) position solutions to obtain an estimated position. This solution is generally in terms of a standard navigational reference frame, for example WGS-84 (World Geodetic System—latitude and longitude), earth-centered-earth-fixed (ECEF). Many such coordinate systems or reference frames have been developed and are used by the military and by civilians for navigation and more generally to describe a position on earth. In the known vehicle location systems, the position of the vehicle is transmitted to the remote location in terms of these reference frames, e.g. latitude and longitude. The dispatcher (or other person at the remote location) may then attempt to convert the latitude/longitude information to a street address or intersection.

This is inadequate for several reasons. First, the position information transmitted from the vehicle includes the error in the GPS position solution. Further, the dispatcher (or a computer at the remote location) must interpret the latitude/longitude data and convert it to the road network (i.e. street address or street intersection). As a result, as far as the dispatcher can determine, there may be many streets or many addresses at which the vehicle could be located.

### SUMMARY OF THE INVENTION

The present invention provides an improved method and system for transmitting the position of a vehicle to a remote location. In the present invention, the position of the vehicle is calculated at the vehicle relative to a map database stored in the vehicle system using known techniques used in vehicle navigation systems. In one feature of the present invention, the vehicle navigation system calculates its position relative to the map database using map matching techniques prior to sending that calculated position to the remote location, thus providing a more accurate calculation of the vehicle position. The position of the vehicle is then transmitted to the remote location in terms relative to the stored map database. In other words, the position of the vehicle is communicated to the remote location in terms of the geocoded road network location, rather than simply latitude and longitude.

Throughout the world exists an elaborate system of roads and highways. Typically when a land vehicle is moving from one place to another, the source, destination, as well as the entire route are all most conveniently described in terms of the road network. Mailing addresses are in terms of the road network. In the present invention, the vehicle location is presented to the dispatcher (or other person at the remote location) in terms of the geocoded network location.

Vehicle location for services such as fleet management, emergency notification, autonomous vehicle location, etc. can therefore benefit greatly from the transmission of the vehicle position relative to the geocoded road network location.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is schematic of the vehicle location system of the present invention.

### DETAILED DESCRIPTION

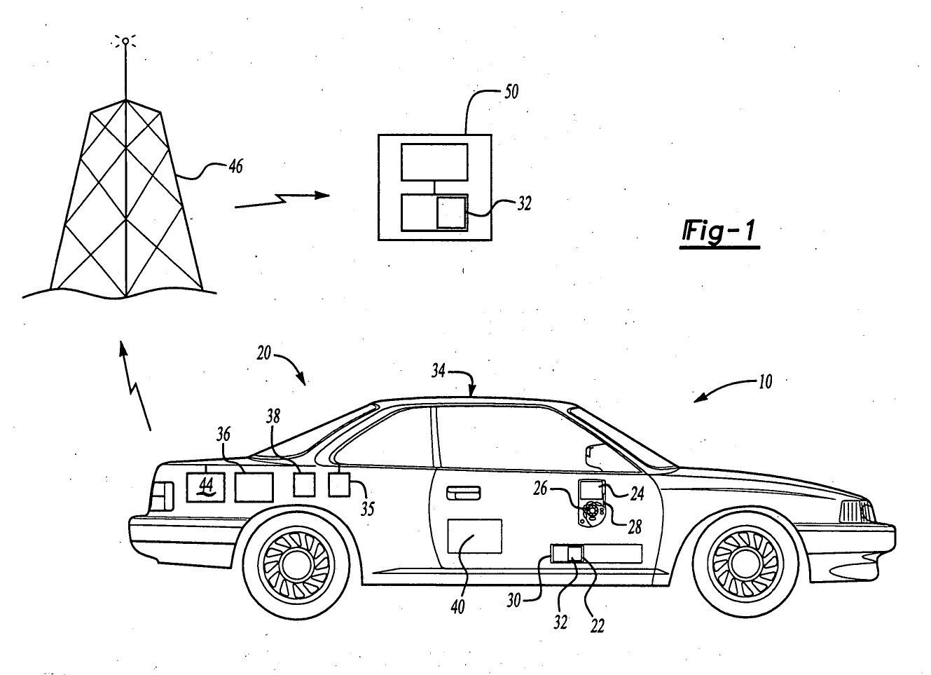

The vehicle location system 10 of the present invention is shown schematically in FIG. 1. The vehicle location system 10 includes a vehicle navigation system 20. The navigation system 20 includes a CPU 22 connected to a display 24, such as a high resolution LCD or flat panel display. The CPU 22 is also connected to a user input device 26 such as a mouse, keyboard, key pad, remote device or microphone.

The user input device 26 is preferably a keypad comprising a plurality (preferably eight) of direction arrows which operate together with the display 24 to enter text, numbers, symbols, etc. or other alphanumeric characters. Alternatively, the display 24 can be a touch screen display. The user input device 26 further provides inputs for a user to request emergency assistance and/or to selectively transmit the current location of the navigation system 20 to a remote location.

The CPU 22 includes at least one audio speaker 28 for outputting sound derived from the CPU 22 and a storage device 30, such as a hard drive 30 and/or CD ROM, connected to the CPU 22. The storage device 30 contains a database 32 including a map of the road network in the area to be traveled including road segments, sub-segments, road intersections and street addresses and the latitude and longitude of the street segments, sub-segments, road intersections, and street addresses. The database 32 also includes the locations of potential destinations, such as addresses, hotels, restaurants, or previously stored locations. The software for the CPU 22, including the graphical user interface, route guidance, operating system, position-determining software, etc may also be stored in storage device 30 and/or in RAM, ROM, flash memory, etc.

The navigation system 20 also includes position determining devices, such as a GPS

receiver 35, a gyroscope 36, a compass 38, or a multi-axis accelerometer 40, all connected to the CPU 22 (connections not shown for simplicity). Suitable position and motion determining devices are well known and are commercially available. Different combinations or subsets of these devices could be used, as well as additional position determining devices, such as a wheel speed sensor or speedometer. The navigation system 20 is installed in a vehicle 34.

Using information from the position determining devices, the system 20 continuously matches measured vehicle location to the map database 32. An optimal estimate of the position of the vehicle 34 on the road network in the map database 32 (called the map-matched position) is then computed. The current location of the vehicle 34 may be displayed on display 24 relative to the surrounding roads. Many techniques are known for the integration of information from the various position-determining devices and map-matching. Any of these techniques for determining the position of the vehicle 34 relative to the database 32 of roads can be used, as the specific techniques form no part of the present invention.

In the present invention, the map-matched position of a vehicle relative to an on-board database is transmitted to another location, such as a base station or even another vehicle. The map-matched position is not a street address or latitude and longitude coordinates but rather is a mathematically determined position based on the input from external sensors, such as a GPS receiver or gyrocompass, etc., or a combination thereof.

The sensor output is inputted to a statistical filter along with estimated probable locations relative to a map database. The statistical filter then performs iterations to narrow the probable locations to one position based on the map database coordinates. These coordinates are equated to a map database “LOCUS”. The locus point is the position relative to the geocoded location on the street. Thus, in the present invention, a map-matched position LOCUS point relative to an on-board map database is transmitted to another location.

As is known in navigation systems, the user can select a destination relative to the database 32 of roads utilizing the input device 26 and the display 24. The navigation system 20 can then calculate and display a recommended route directing the driver of the vehicle 34 to the desired destination. The navigation system 20 can display turn-by-turn instructions on display 24 along with corresponding audible turn-by-turn instructions via the speaker 28, guiding the driver to the desired destination.

The navigation system 20 further includes a transceiver 44, such as (or similar to) a cellular phone, PCS, satellite phone, RF, microwave or other wireless communication system. The transceiver 44 is connected to the CPU 22, which includes the appropriate communication software, such as Internet software. The transceiver 44 communicates with a plurality of complementary transceivers 46 (one shown) such as cell towers or a satellite. The transceiver 46 is connected via telephone lines, additional wireless links (such as cell towers or satellites), and/or the Internet to a second location 50 remote from the vehicle 34 and generally comprising a CPU 52, preferably with graphical user interface and mass storage including the database 32 (or similar). In general, “LOCUS” information is exchanged between the second location 50 and the navigation system 20 via the transceivers 46, 44. Details of the information exchanged will be described below; however, one of ordilary skill in the art could provide the appropriate software to implement the functions described or different hardware and/or software to facilitate the exchange of information.

In operation, the navigation system 20 of the present invention continuously determines the map-matched position of the vehicle 34. The navigation system 20 then transmits the map-matched LOCUS position of the vehicle 34 to the second location 50. This can be done periodically, in the case of a fleet monitoring system, or when necessary in an emergency assistance request system. Transmission of the map-matched position requires little bandwidth and can be done on an ‘as-needed’ basis whereas the alternative of transmitting all the ‘real-time’ sensor data (acceleration, turn rate, etc.) would generally be impractical.

The LOCUS position information transmitted by the navigation system 20 to the second location 50 is with reference to the map database 32. Since the second location 50 includes the same map database 32, then the progress of the vehicle 34 can be monitored, such as on a display. If the second location 50 is an emergency assistance dispatch station, then emergency

assistance can be dispatched to the vehicle location with reference to the road network, i.e. a street address, intersection or a distance and direction from a street address or intersection. As another alternative, or additionally, the second location 50 could be another vehicle, which would include the CPU 52.

The navigation system 20 of the present invention provides more accurate position information to the second location 50 because the position is calculated using map-matching. Further, the information is more useful and transmitted more efficiently, because it is given with reference to the map database 32 and consequently, with reference to the real world road network.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. The navigation system 20 is preferably a Magellan™ 750NAV™ navigation system, with the addition of the transmission of the vehicle location in terms of the map database.

What claimed is:

1. A method of transmitting a vehicle location to another location remote from the vehicle location, the method comprising:
sensing the vehicle location with a Global Positioning System (GPS) unit;
performing map matching of the sensed vehicle location with respect to an on-board previously stored map database by performing iterations with a statistical filter provided with the sensed vehicle location from the GPS unit and estimated probable locations relative to the map database coordinates;
equating the map matched position coordinates to a map database LOCUS, the LOCUS point being the position relative to the geocoded location; and
transmitting one of the map matched position coordinates or LOCUS point to the another location remote from the vehicle location.

2. The method of claim 1, wherein the map matched position coordinates or LOCUS point are wirelessly transmitted to the another location remote from the vehicle location.

3. The method of claim 1, further comprising storing the previously stored map database on an on-board storage unit.

4. The method of claim 3, wherein the on-board storage unit comprises a hard drive.

5. The method of claim 3, wherein the on-board storage unit comprises a CD ROM.

6. The method of claim 1, further comprising map matching with a Central Processing Unit (CPU).

7. The method of claim 1, further comprising statistical filtering with a Central Processing Unit (CPU).

8. The method of claim 1, further comprising equating the map matched position coordinates to a map database LOCUS with a Central Processing Unit (CPU).

9. The method of claim 1, further comprising displaying the map matched position of the vehicle relative to the map database with a display unit.

10. An apparatus for transmitting a vehicle location to another location remote from the vehicle location, the apparatus comprising:
a Global Positioning System (GPS) unit arranged to sensed the vehicle position;
an on-board storage unit arranged to store a map database, the map database being previously stored in the on-board storage unit;
a map matcher including a statistical filter, the map matcher being arranged to perform map matching of the sensed vehicle location with respect to the previously stored map database stored on the on-board storage unit by performing iterations with the statistical filter provided with the sensed vehicle location from the GPS unit and estimated probable locations relative to the map database coordinates, the map matcher equating the map matched position coordinates to a map database LOCUS, the LOCUS point being the position relative to the geocoded location; and
a transmitter arranged to transmit one of the map matched position coordinates or LOCUS point to the another location remote from the vehicle location.

11. The apparatus of claim 10, wherein the transmitter comprises a wireless transmitter.

12. The apparatus of claim 10, wherein the on-board storage unit comprises a hard drive.

13. The apparatus of claim 10, wherein the on-board storage unit comprises a CD ROM.

14. The apparatus of claim 10, wherein the map matcher including a statistical filter comprises a Central Processing Unit (CPU).

15. The apparatus of claim 10, further comprising a display unit arranged to display the map matched position of the vehicle relative to the map database.

16. The apparatus of claim 10, wherein the transmitter comprises a cellular telephone.

17. The method of claim 1, further comprising transmitting one of the map matched position coordinates or LOCUS point to the another location remote from the vehicle location with a cellular telephone.
